(19) United States
(12) Patent Application Publication
(10) Pub. No.: US 2015/0075897 A1
(43) Pub. Date: Mar. 19, 2015

(54) Slip Yoke Assembly For Automotive Drive Train

(71) Applicant: Sonnax Industries, Inc., Bellows Falls, VT (US)

(72) Inventor: Brian T. Copeland, Keene, NH (US)

(21) Appl. No.: 14/485,251

(22) Filed: Sep. 12, 2014

Related U.S. Application Data
(60) Provisional application No. 61/876,815, filed on Sep. 12, 2013.

(51) Int. Cl. F16D 3/10; B60K 17/22

(52) U.S. Cl. CPC F16D 3/10; B60K 17/22
USPC 180/383; 464/162

(57) ABSTRACT

Automotive drive shafts having slip yoke assemblies that are designed and configured to transmit torque and allow for axial movement while also minimizing driveline vibrations. In some embodiments, the slip yoke assemblies may include one or more bearings that minimize angular misalignment and resist drive shaft bending forces. In some embodiments, the bearings may include a pair of precision mating diameters on a yoke shaft and splined sleeve. In yet other embodiments, the slip yoke assembly may include internal rod wipers to seal out environmental contaminants and retain lubricants.

### RELATED APPLICATION DATA

This application is a non-provisional of U.S. Provisional Patent Application Ser. No. 61/876,815, filed on Sep. 12, 2013, titled “Slip Yoke Assembly,” which is incorporated by reference herein in its entirety.

### FIELD OF THE INVENTION

The present invention generally relates to the field of automobile driveshafts. In particular, the present invention is directed to slip yoke assemblies for use in automobile driveshafts.

### BACKGROUND

Automotive drive train assemblies typically include a driveshaft (sometimes referred to as a propshaft), which is used to transmit rotational power (torque) from a driving member, such as the transmission, to a driven member, such as the front or rear axle. Driveshafts generally need to not only transmit torque, but also accommodate angular misalignment between the transmission and axle assemblies, as well as axial length changes caused by movement of the axle assembly due to the action of the vehicle's suspension. The angular misalignment requirements are frequently met through the use of universal joints (u-joints) at the driveshaft connection points at both the driving and driven member ends of the shaft. The driveshaft axial length change requirements are typically met through the use of a slip yoke assembly.

Slip yoke assemblies typically consist of an externally-splined component engaged within an internally-splined component to transmit torque from one rotating shaft to another rotating shaft via the mating splines. The mating splines are configured for relative axial movement, or slip, which accommodates any necessary driveshaft length changes that occur in operation. The mating splines also must prevent angular misalignment and resist bending forces between the driving and driven components. The spline fit, however, can be inconsistent or inadequate due to variations in the spline design, manufacturing process and methods, and due to subsequent wear that may occur in operation. Such inconsistencies or inadequacies can lead to lateral instability of the yoke shaft/sleeve interface. In turn, this can lead to increased overall instability in the driveshaft when rotating at speed, which can contribute to undesirable driveline disturbances, commonly described as driveline Noise, Vibration and Harshness (“NVH”). NVH can occur at any driveshaft torsional load and rotational speed. Though harmful to vehicle performance and occupant comfort whenever it occurs, it is especially detrimental in high performance vehicle drive trains, where relatively high driveshaft torsional loads and rotational speeds are a common occurrence. For example, some high performance applications might develop driveshaft torsional loads of 1,000 lb-ft or more and driveshaft rotational speeds of 9,000 rpm.

Also contributing to NVH in many existing slip yoke designs is the use of a bellows-type rubber boot to seal out environmental contaminants and retain lubricants within the slip yoke assembly. The boots typically lack precision guidance features to ensure they remain centralized about the driveshaft axis while the driveshaft is rotating. Any amount of imbalance caused by this eccentricity will translate into shaft imbalance, resulting in vibration. Since the boot is not prevented from shifting laterally during rotation, the magnitude and location of the imbalance can vary and be unpredictable. Along with these negative characteristics is a tendency for the rubber boot to develop surface cuts or breaks over time that allow contaminants to enter the slip yoke assembly.

### SUMMARY OF THE DISCLOSURE

In one implementation, the present disclosure is directed to a slip yoke assembly for use in an automobile driveshaft. The slip yoke assembly includes an outer sleeve having an inner lumen and an internal spline located in a portion of said inner lumen; a yoke shaft slidably disposed within said inner lumen and configured for movement over a working stroke between a fully-inserted position and a design-maximum-extended position, said yoke shaft having an external spline configured to engage said internal spline to form a splined joint; and at least one bearing surface disposed between the outer sleeve and yoke shaft and spaced from the splined joint, said bearing surface configured and dimensioned to resist angular misalignment between said splined sleeve and said yoke shaft.

In another implementation, the present disclosure is directed to an aftermarket slip yoke assembly for use in a replacement driveshaft for replacing an automobile original equipment driveshaft of an automobile drive train. The slip yoke assembly includes a splined sleeve having a proximal end; a yoke shaft slidably disposed within said splined sleeve and forming a splined joint therebetween, said yoke shaft having an outer surface; wherein said proximal end of said splined sleeve includes a rod wiper groove configured to house a rod wiper in direct contact with said yoke shaft outer surface to thereby prevent contaminants from entering said slip yoke assembly.

In yet another implementation, the present disclosure is directed to an automobile drive train. The automobile drive train includes an engine and transmission configured to deliver torque to a driveshaft; a rear differential mounted on a suspension configured to receive torque from the driveshaft, the suspension permitting movement of the rear differential relative to the engine and transmission; wherein said driveshaft comprises a slip yoke assembly having; an outer sleeve having an internal spline; a yoke shaft slidably disposed within said outer sleeve, said yoke shaft having an external spline configured to engage said internal spline to form a splined joint; and at least one bearing surface disposed between the outer sleeve and yoke shaft and spaced from the splined joint, said bearing surface configured and dimensioned to resist angular misalignment between said splined sleeve and said yoke shaft

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1A is a schematic of an example vehicle drive train having a slip yoke assembly;

FIG. 1 is an exploded isometric view of an example slip yoke assembly;

FIG. 2 is a cross sectional view of the slip yoke assembly of FIG. 1;

FIG. 3 is an end view of the slip yoke assembly of FIGS. 1 and 2;

FIG. 4 is another cross sectional view of the slip yoke assembly of FIGS. 1-3;

FIG. 5 is an enlarged section view of a portion of the slip yoke assembly of FIGS. 1-4;

FIG. 6 is another cross sectional view of the slip yoke assembly of FIGS. 1-5; and

FIG. 7 is another cross sectional view of the slip yoke assembly of FIGS. 1-6.

### DETAILED DESCRIPTION

Automotive drive shafts having slip yoke assemblies are provided that are designed and configured to transmit torque and allow for axial movement while also minimizing driveline vibrations. In some embodiments, the slip yoke assemblies may include one or more bearings that minimize angular misalignment and resist drive shaft bending forces. In other embodiments, the bearings may include a pair of precision mating diameters on a yoke shaft and splined sleeve. In yet other embodiments, the slip yoke assembly may include internal rod wipers to seal out environmental contaminants and retain lubricants.

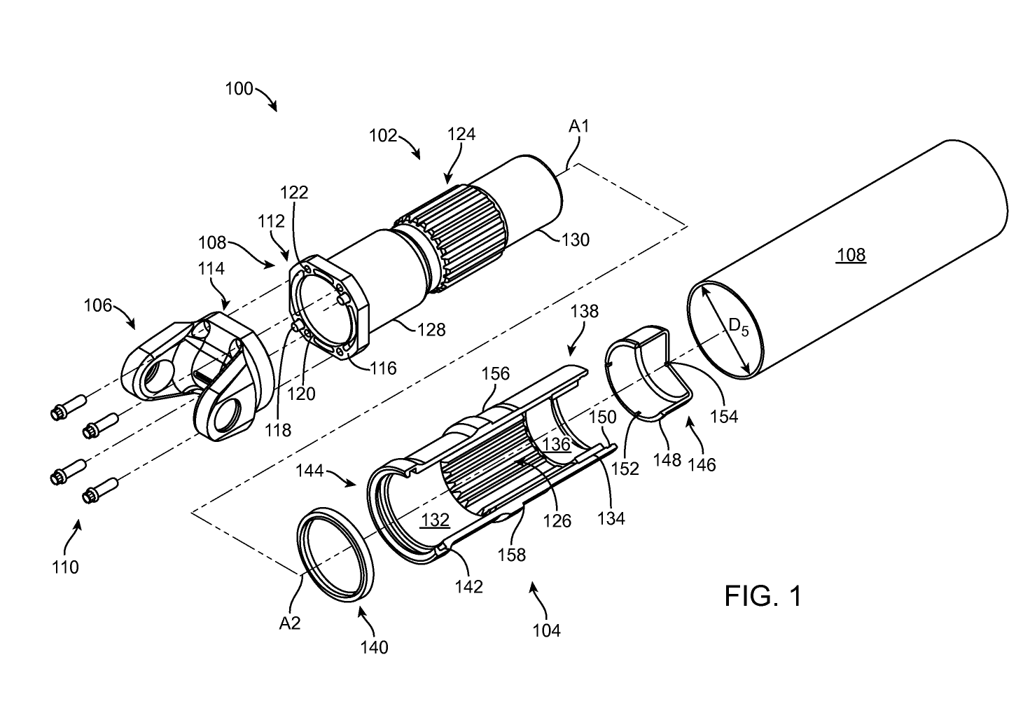

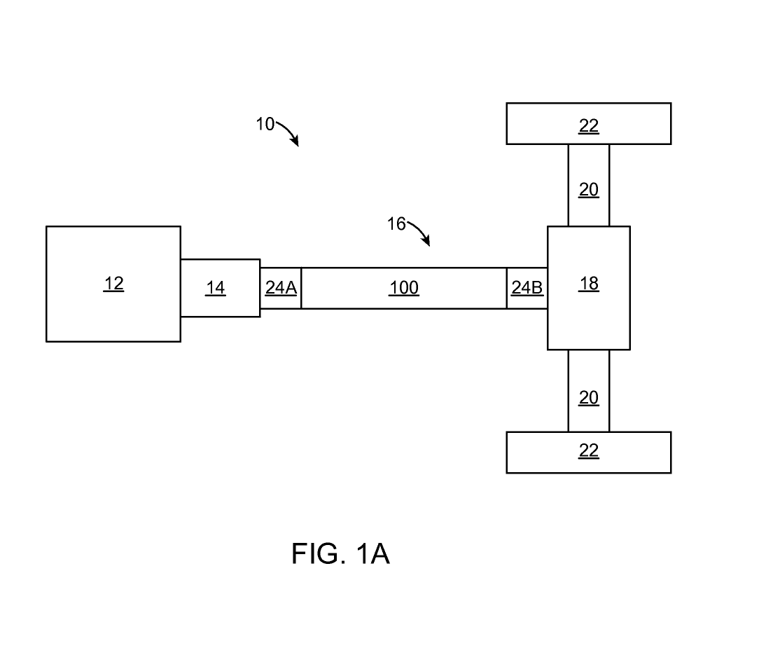

FIG. 1A illustrates an example automobile drive train 10 that includes components such as an engine 12, and a transmission 14 and driveshaft 16 for transfer of engine torque to a differential 18, which in turn transmits the torque to wheels 22 via axle shafts 20. Differential 18 is configured to move relative to transmission 14, such that driveshaft 16 must be able to accommodate varying angular alignments and axial distances between the transmission and differential. To accommodate varying angles and axial distances, driveshaft 16 includes universal joints 24 or other appropriate flanges and/or pinion yokes, ect., and a slip yoke assembly 100 for coupling transmission 14 to differential 18. Universal joints 24A and 24B allow for angular misalignment, and slip yoke assembly 100 allows for changes in axial length due to, for example, movement of differential 18 relative to transmission 14. Various slip yoke assemblies 100 are described and disclosed herein that provide for torque transmission and axial movement. Embodiments described herein also provide opportunities for minimizing driveline NVH and weight and increasing driveline strength and operating speeds.

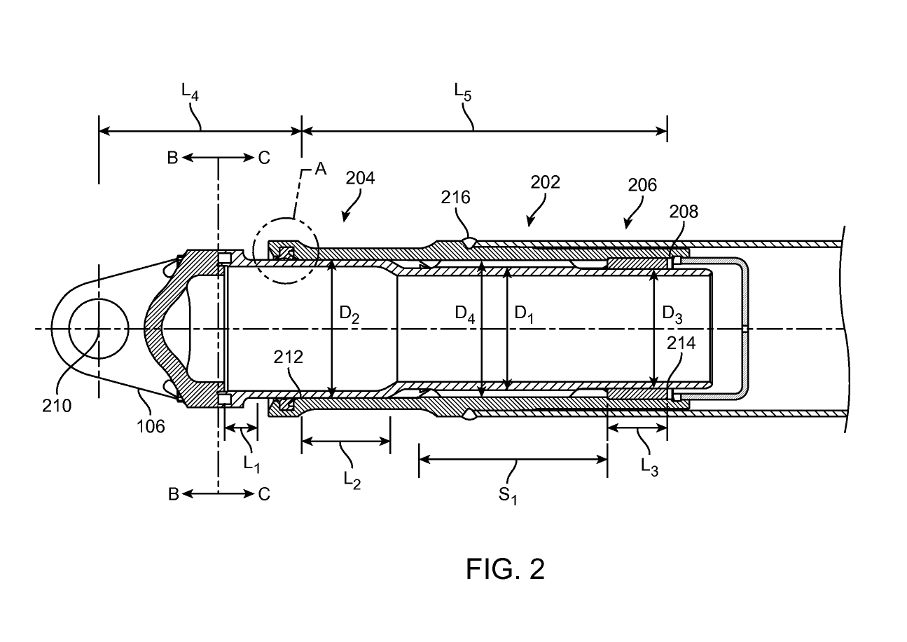

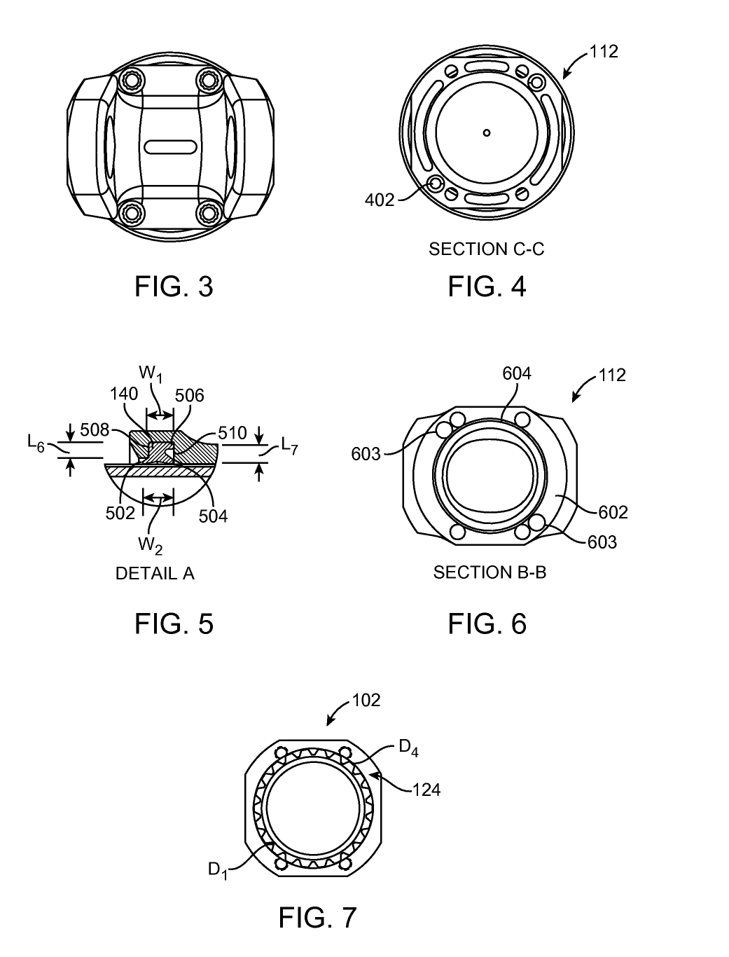

FIGS. 1-7 illustrate an example embodiment of a slip yoke assembly 100 made in accordance with the present invention that is configured and dimensioned to transmit torque while allowing for axial movement with minimal NVH. FIG. 1 is an isometric exploded view of example slip yoke assembly 100, which includes a yoke shaft 102 having a first central longitudinal axis A1 configured to be slidably disposed within a splined sleeve 104 having a second central longitudinal axis A2, which forms a splined joint 202 (FIG. 2) that enables torque transmission while also allowing relative axial movement over a working stroke distance L1 (FIG. 2). The working stroke distance L1 is the distance between a fully-inserted position and a design-maximum-extended position. Illustrated slip yoke assembly 100 may have a variety of working strokes, depending, for example, on the intended application. For example, the working stroke may be in the range of approximately 1 inch to approximately 2 inches. FIG. 2 shows slip yoke assembly 100 in an assembled state, in a mid-stroke position, approximately halfway between a fully-inserted position and a design-maximum-extended position.

Illustrated slip yoke assembly 100 is designed to couple to a detachable flange yoke 106, which forms part of universal joint 24 (FIG. 1) and is designed to couple to a mating flange yoke of universal joint 24A. Splined joint 202 (FIG. 2) of slip yoke assembly 100 facilitates transmission of torque from a driving member, e.g., vehicle transmission 14 (FIG. 1A), to a driven member, e.g., differential 18 (FIG. 1A), by way of a mating driveshaft tube 108 and any necessary mating components and hardware, e.g., u-joints, flange and/or pinion yokes, etc. 24.

Turning to each of the slip yoke assembly's 100 components in more detail, example slip yoke assembly includes detachable flange yoke 106, which is removeably coupled to a proximal end 108 of yoke shaft 102 with a plurality of bolts or screws 110. Having a detachable flange yoke 106 may provide several benefits, including ease of manufacturing and increased flexibility in material selection. For example, in the illustrated embodiment, flange yoke 106 may be formed from cast aluminum, while illustrated yoke shaft 102 may be formed from steel with additional anti-friction coatings. Thus, having a detachable flange yoke 106 potentially addresses different design considerations relevant to optimizing weight, strength, and dynamic balance for flange yoke 106 and yoke shaft 102. Alternative slip yoke assembly embodiments may have a flange yoke that is integrally formed with yoke shaft 102, or otherwise not removeably coupled to the yoke shaft. In yet other embodiments, flange yoke 106 may be made from materials other than aluminum, and the flange yoke and yoke shaft 102 may be made from the same type of material.

As shown in FIGS. 1 and 2 and in greater detail in FIGS. 4 and 6, illustrated flange yoke 106 and yoke shaft 102 may have various precision locating features 112 that facilitate ease of assembly of the flange yoke to the yoke shaft and ensure the flange yoke is precisely located relative to the yoke shaft to ensure optimal vibration performance, including at high rotational speeds. In the illustrated embodiment, complementary precision locating features 112 are located on proximal end 112 of yoke shaft 102 and distal end 114 of flange yoke 106. Locating features 112 include precision locating faces 116 and 602 (FIG. 6) which ensure proper angular alignment. Locating features 112 in the illustrated embodiment also include a pair of alignment pins 118 located approximately 180 degrees apart from one another on shaft proximal end 112, and a complementary pair of alignment pin recesses 603 (FIG. 6) on flange distal face 114. Illustrated alignment pins 118 are hollow to minimize weight and integrally formed with shaft proximal face 112. Alternative embodiments may have less or more than two alignment pins 118, pins separated by less or more than 180 degrees, and may also have one or more pins located in flange distal face 114 with complementary recesses in shaft proximal face 116. Precision locating features 112 also include a precision locating inner diameter 120 on shaft proximal face 116 that is configured to slidably couple to precision locating outer diameter 604 (FIG. 6) on flange distal face 114. Shaft proximal face 116 also includes a pattern of threaded holes 122 (only one labeled to avoid clutter) for engagement with bolts 110.

Illustrated yoke shaft 102 and splined sleeve 104 are designed and configured with complementary features that facilitate torque transmission and relative axial movement and may also improve vibrational performance. Illustrated shaft 102 and sleeve 104 include splined joint 202 (FIG. 2) comprising an external spline 124 formed in an outer surface of shaft 102 that is configured and dimensioned to mate with an internal spline 126 formed in an inner wall of sleeve 104. FIG. 7 further illustrates shaft 102 viewed from a proximal end of the shaft and showing external spline 124. Shaft 102 and sleeve 104 also include a proximal bearing 204 (FIG. 2) and a distal bearing 206 located on opposite ends of splined joint 202. Proximal and distal bearings 204 and 206 are configured and dimensioned to prevent angular misalignment of the driveshaft and resist bending forces transmitted to the slip yoke assembly 100 by other driveline components, and function as the primary source of slip yoke location and alignment. Thus, proximal and distal bearings 204 and 206 can minimize primary sources of driveline NVH, which may enable higher rotational speeds and optimal vibrational performance. Also, splined joint 202 does not need to be designed to resist bending forces or angular misalignment such that a length S1 of the splined joint 202 may be less than in conventional slip yoke assemblies and the manufacturing tolerances of one or both of internal and external splines 124 and 126 may be relaxed without substantially impacting NVH performance. With such features, vibrational performance of slip yoke assembly 100 should not be appreciably impacted by wear of the internal or external splines, which can increase durability and lifetime of assembly 100.

In the illustrated exemplary embodiment, proximal and distal bearings 204 and 206 are formed from proximal and distal outer locating diameters 128 and 130 (FIG. 1) on shaft 102 and proximal and distal inner locating diameters 132 and 134 on sleeve 104. Thus, in the illustrated example, shaft proximal locating diameter 128 and sleeve proximal locating diameter 132 are configured to come into direct sliding contact, thereby forming a bearing surface therebetween and forming proximal bearing 204. In alternative embodiments, additional or alternative structures such as bushings or other separate bearings may be added to form all or part of the proximal bearing. Illustrated distal bearing 206 also includes a reducer bushing 136 that is sized to be positioned between distal inner and outer locating diameters 130 and 134 and form a bearing surface between an inner surface of bushing 136 and distal outer locating diameter 130. Bushing 136 may be inserted into a distal end 138 of sleeve 104 and, in the illustrated embodiment, the bushing is held in place via an interference fit between an outer diameter of the bushing and distal inner locating diameter 134. Assembly 100 may also include a retaining ring 208 (FIG. 2), which is used to ensure the bushing does not move axially in operation. Because illustrated inner and outer locating diameters 128-134 are simple, round features, a precision slip fit may be achieved using relatively straightforward and common manufacturing processes and methods. In operation, locating diameters 128-134 and external and internal splines 124 and 126 are free to slide axially relative to each other, thereby providing the axial length change characteristics required of the driveshaft.

As shown in FIG. 2, in the illustrated embodiment, shaft 102 has a stepped-outer-diameter design, where shaft distal outer locating diameter 130 (FIG. 1) has a diameter D3 (FIG. 2) that is less than a diameter D2 (FIG. 2) of shaft proximal outer locating diameter 128. D3 is also slightly less than a minor diameter D1 (FIGS. 2 and 7) of the splined joint 202 and D2 is slightly greater than a major diameter D4 (FIGS. 2 and 7) of the splined joint 202. Both of sleeve locating diameters 132 and 134 have a diameter that is slightly greater than shaft proximal diameter D2. Having sleeve 104 with inner locating diameters 132 and 134 that are larger than splined joint major diameter D4 facilitates ease of manufacturing internal spline 126, for example, with a broaching machine process. Shaft 102 stepped outer diameter can facilitate assembly by allowing shaft distal locating diameter 130 to be inserted past internal spline 126.

As also shown in FIG. 2, proximal bearing 204 extends along an axial contact length L2 and has a corresponding bearing surface area, and distal bearing 206 extends along an axial contact length L3 and has a corresponding bearing surface area. In the illustrated embodiment, when shaft 102 is fully inserted in sleeve 104, length L2 is approximately equal to the length of sleeve internal locating diameter 132. As shaft 102 extends out of sleeve 104, the length of L2 decreases. As described above, FIG. 2 shows assembly 100 in a mid-stroke position such that length L2 illustrated in FIG. 2 is approximately half way between a maximum axial contact length when shaft 102 is fully inserted and a minimum contact length when the shaft is fully extended to the design maximum extended position. In the illustrated example, length L3 is equal to the width of bushing 136. As shown, length L2 and the corresponding bearing surface area of proximal bearing 204 is greater than length L3 and the corresponding bearing surface area of distal bearing 206. Such a length differential can allow proximal bearing 204 to function as a primary radial load bearing, while distal bearing 206 can have a primary function of axial alignment and a secondary function of radial load. In the illustrated embodiment, a minimum ratio of axial contact length L2 or L3 to its corresponding shaft diameter D2 or D3 (L2/D2 or L3/D3) when shaft 102 is in a design maximum extended position is in the range of about 0.6 to about 2.0. In the illustrated exemplary embodiment, L3/D3 may be closer to approximately 0.6 and L2/D2 may be closer to approximately 2. In other examples L3/D3 may be substantially the same as L2/D2 or less than L2/D2. In yet other embodiments, one or both of L2/D2 and L3/D3 may in the range of about 0.5 to about 2.1; or about 0.7 to about 1.9; or about 0.8 to about 1.8; or about 0.9 to about 1.7; or about 1.0 to about 1.6; or about 1.1 to about 1.5, or about 1.2. In yet another example, over the entire operating stroke, both proximal bearing 204 and distal bearing 206 have a minimum L/D ratio (L2/D2 or L3/D3) of about 0.6 or about 0.65 or about 0.67, or about 0.7

In the illustrated embodiment, proximal and distal bearings 204 and 206 are separated by a relatively large distance as compared to a corresponding spline length of engagement in a conventional slip yoke, resulting in improved support of yoke shaft 102 in both static and dynamic conditions, especially when at design maximum extended position, or full extension. The fixed locations of sleeve internal locating diameters 132 and 134 results in an overall yoke shaft supported length L5 (FIG. 2) that does not vary in operation, which may further improve stability. Likewise, the effects of any clearance between mating locating diameters 128-134 of yoke shaft 102 and splined sleeve 104 may be minimized due to the relatively large distance between the proximal and distal diameters. Therefore, manufacturing variables and operational wear may be less critical to the performance of the assembled unit.

With assembly 100 in the mid-stroke position shown in FIG. 2, assembly 100 has an unsupported length L4 extending from an axis of rotation 210 of flange 106 to a proximal end 212 of proximal bearing 204. As shown in FIG. 2, in the illustrated embodiment, unsupported length L4 varies depending on the position of shaft 102, with assembly 100 having a maximum unsupported length L4 when the shaft is in the design maximum extended position, and a minimum unsupported length L4 when the shaft is fully inserted into sleeve 104. Assembly 100 has supported length L5 extending from proximal end 212 of proximal bearing 204 to distal end 214 of distal bearing 206. In the illustrated embodiment, the ratio of supported length L5 to shaft proximal outer diameter D2 (L5/D2) may be greater than or equal to 2.5. For a given load, providing a L5/D2 ratio of ≧2.50 serves to reduce the individual bearing loads imparted to each of proximal and distal bearings 204 and 206 caused by shaft bending as compared to the loads imparted in a splined section of conventional yoke shafts. By including proximal and distal bearings 204 and 206 and providing a L5/D2 of ≧approximately 2.5, the loads applied to splined joint 202 are reduced, thereby reducing spline wear and improving shaft alignment. In other embodiments, L5/D2 may be equal to or greater than 2.0, or 2.2, or 2.4, or 3.0. Also, in the illustrated embodiment, the ratio of supported length L5 to unsupported length L4 (L5/L4) when shaft 102 is at the maximum design extended position is greater than or equal to about 1.5. For example, illustrated assembly 100 has a minimum ratio of supported length to unsupported length of about 1.5. Having a minimum L5/L4 ratio of ≧approximately 1.5 serves to reduce the misalignment effects caused by any clearance present between the mating yoke shaft 102 and sleeve locating diameters 128-134. In other embodiments, the yoke shaft assembly may have a minimum L5/L4 ratio of about 1.75 or 2.0.

In the illustrated embodiment, yoke shaft 102 may be made from steel, for example, low carbon steel or alloy steel, and splined sleeve 104 and reducer bushing 136 may be made from aluminum, for example, 6061-T4 or 6061-T6 aluminum. Illustrated alignment pins 118 (FIG. 1) may be made from steel. The illustrated shaft 102 also may have an anti-friction coating, for example, a Nylon 11 coating. In alternative embodiments, the shaft may have a hard-anodic coating with a friction reducing additive such as PTFE. In yet other embodiments, shaft 102 may also be made from aluminum, such as 6061-T4 or 6061-T6 aluminum.

Slip yoke assembly 100 may also include various features to prevent contaminants from entering the assembly while also providing lubricant retention. The sealing features in illustrated assembly 100 include a rod wiper 140 disposed within a rod wiper groove 142 in a proximal end 144 of sleeve 104 and a cup plug 146 coupled to distal end 138 of the sleeve. As shown in FIG. 2 and in greater detail in FIG. 5, illustrated rod wiper 140 has two sealing lips, 502 and 504, which are configured to contact proximal outer diameter 128 of yoke shaft 102. Sealing lip 502 serves to prevent environmental contaminants from entering the inner workings of assembly 100 and sealing lip 504 limits the escape of lubricants, such as grease, from the assembly. Rod wiper 140 is retained in sleeve 104 by way of groove 142. A third sealing lip 506 serves to prevent environmental contaminants from entering the assembly via a path between the outer diameter of wiper 140 and groove 142. As best seen in FIG. 5, illustrated rod wiper groove 142 has a width W1 that is less than a width W2 of rod wiper 140 extending between sealing lips 502 and 504, which may help maintain rod wiper 140 in the appropriate location, and may improve the effectiveness of sealing lip 502. Rod wiper groove 142 also has a proximal wall 508 (FIG. 5) having a length L6 and a distal wall 510 having a length L7. In the illustrated embodiment, L6 is less than L7, which may also help maintain rod wiper 140 in the appropriate location, and improve the effectiveness of sealing lip 502. Rod wiper 140 may be made from a variety of materials, including various types of rubbers, or polymers, including, for example, polyurethane.

Illustrated cup plug 146 is designed to couple to distal end 138 of sleeve 104. In the example embodiment, cup plug 146 has a lip 148 that is sized and configured to be positioned in a cup plug groove 150 in sleeve 104 to thereby secure the cup plug to the sleeve. Cup plug 146 also has a plurality of notches 152 (only one labeled to avoid clutter), which allow deformation of lip 148 for ease of installation. Cup plug 146 also includes a vent hole 154, which is designed to prevent pressure buildup within slip yoke assembly 100 during operation, while minimizing entry of contaminants and maximizing lubrication retention. Illustrated vent hole 154 is a single orifice located substantially in a center of cup plug 146. Cup plug 146 may be made from a variety of materials, including a variety of types of composite plastics.

Illustrated assembly 100 also includes mating driveshaft tube 108, which couples assembly 100 to downstream drive train components. In the illustrated embodiment, driveshaft tube 108 has an inner diameter D5 (FIG. 1) that is sized and configured for an interference fit with a sleeve outer locating diameter 156. Sleeve outer locating diameter 156 is designed to provide a precision location and alignment of assembly 100 and tube 108. Sleeve 104 also has a shoulder 158 for precise axial location of mating driveshaft tube 108. As shown in FIGS. 1 and 2, outer locating diameter 156 and shoulder 158 are located adjacent splined joint 202 and positioned between proximal and distal bearings 204 and 206. Such a location ensures that any inadvertent material distortion due to attachment of tube 108 to sleeve 104, such as distortion due to welding, does not impact bearings 204 and 206. Illustrated sleeve 104 may be secured to tube 108 in a variety of ways, including via welding, such as a single welded joint 216 where sleeve 104 abuts shoulder 158 (FIG. 2). Illustrated tube 108 may be made from a variety of materials, including aluminum or a carbon fiber composite, in which case joints may be integrally bonded rather than welded.

In some embodiments, slip yoke assembly 100 may also include features configured to prevent separation of yoke shaft 102 from splined sleeve 104 during operation. For example, an outer, detachable sleeve or retainer may be fastened to either the yoke shaft or splined sleeve (not shown). The sleeve or retainer may be designed to make contact with a shoulder, retaining ring or other such feature or device on the mating yoke shaft or splined sleeve, but would otherwise be free to move axially along with the component it is fastened to. The additional retaining feature would limit the amount of axial movement, thereby preventing separation of the yoke shaft from the splined sleeve. In other embodiments, the retaining feature may be positioned internally within the slip yoke assembly. In yet other embodiments, a retaining feature may be incorporated into the splined sleeve. For example, the retaining feature may include a plurality of pins mounted radially on the periphery of the splined sleeve. For example, the axes of one or more of the pins may extend radially inward to make contact with, for example, a slot, shoulder or other feature on the yoke shaft, thereby limiting the axial movement of the yoke shaft within the assembled unit.

The illustrated yoke shaft assembly is designed and configured to be lightweight while providing opportunities for improved vibrational performance, including in high-performance applications. For example, use of illustrated assembly 100 in an appropriate drive shaft setup may result in a driveshaft dynamic balance equal to or less than approximately 0.10-0.15 oz-in at each end of the driveshaft at approximately 5,000-9,000 rpm. The design drive shaft torque capacity of the assemblies disclosed herein may vary depending on the intended application, for example, maximum design torque capacities may be in a range of approximately 2,500-7,000 lb-ft.

The slip yoke assemblies disclosed herein may be used in a variety of applications, including in an Original Equipment (OE) automobile design, or as an aftermarket improvement for example, an improvement for high-performance applications, including rear wheel drive automobiles, including, for example, independent rear-suspension automobiles. Example applications include later-model Chevrolet Camaros® and modified early or late model Ford Mustangs®, as well as a number of other foreign and domestic automobiles. In one example, the drive shaft of a vehicle having a relatively heavy single or multi-piece steel OE driveshaft may be replaced with a drive shaft including a slip yoke assembly made in accordance with the present invention. Such a replacement can result in a reduction of weight and rotating mass, which is particularly beneficial for high-performance and racing applications.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A slip yoke assembly for use in an automobile driveshaft comprising:
an outer sleeve having an inner lumen and an internal spline located in a portion of said inner lumen;
a yoke shaft slidably disposed within said inner lumen and configured for movement over a working stroke between a fully-inserted position and a design-maximum-extended position, said yoke shaft having an external spline configured to engage said internal spline to form a splined joint; and
at least one bearing surface disposed between the outer sleeve and yoke shaft and spaced from the splined joint, said bearing surface configured and dimensioned to resist angular misalignment between said splined sleeve and said yoke shaft.

2. A slip yoke assembly according to claim 1, wherein said yoke shaft has a proximal end and a distal end, said slip yoke assembly further comprising a flange yoke located at said proximal end, and wherein said at least one bearing surface comprises a proximal bearing located between said proximal end and said splined joint and a distal bearing located between said distal end and said splined joint.

3. A slip yoke assembly according to claim 2, wherein:
said proximal bearing has a first bearing surface area and said distal bearing has a second bearing surface area, and wherein said first bearing surface area is greater than said second bearing surface area.

4. A slip yoke assembly according to claim 2, wherein
said inner lumen of said splined sleeve includes a proximal internal locating diameter and a distal internal locating diameter; and
said yoke shaft includes a proximal outer locating diameter configured for operable engagement with said proximal internal locating diameter and a distal outer locating diameter configured for operable engagement with said proximal internal locating diameter;
wherein said proximal bearing comprises said proximal internal and external locating diameters and said distal bearing comprises said distal internal and external locating diameters.

5. A slip yoke assembly according to claim 4, wherein said proximal outer locating diameter has a first outer diameter and said distal outer locating diameter has a second outer diameter and wherein the first outer diameter is greater than the second outer diameter.

6. A slip yoke assembly according to claim 5, wherein said splined joint has a major diameter and a minor diameter, and wherein the first outer diameter is greater than the major diameter and the second outer diameter is less than the minor diameter.

7. A slip yoke assembly according to claim 4, wherein:
said proximal outer locating diameter has an outer diameter D2 and said distal outer locating diameter has an outer diameter D3; and
wherein, when said yoke shaft is positioned at the design-maximum-extended position, said proximal bearing has an axial contact length L2 and said distal bearing has an axial contact length L3;
wherein at least one of L3/D3 and L2/D2 is at least approximately 0.6.

8. A slip yoke assembly according to claim 2, wherein:
said proximal bearing has a proximal end and said distal bearing has a distal end;
said slip yoke assembly having a supported length extending between said proximal end of said proximal bearing to said distal end of said distal bearing;
wherein, during use, said supported length is constant.

9. A slip yoke assembly according to claim 8, wherein:
when said yoke shaft is positioned at the design-maximum-extended position, said slip yoke assembly has an unsupported length extending between an axis of rotation of said flange yoke and said proximal end of said proximal bearing; and
a ratio of said supported length to said unsupported length is greater than or equal to approximately 1.5.

10. A slip yoke assembly according to claim 9, wherein said yoke shaft has a first outer diameter, and wherein a ratio of said supported length to said first outer diameter is greater than or equal to approximately 2.5.

11. A slip yoke assembly according to claim 1 in combination with an automobile drive train comprising an engine and transmission configured to deliver torque to a driveshaft, and a rear differential mounted on a suspension configured to receive torque from the driveshaft, the suspension permitting movement of the rear differential relative to the engine and transmission, wherein said driveshaft comprises said slip yoke assembly.

12. An aftermarket slip yoke assembly for use in a replacement driveshaft for replacing an automobile original equipment driveshaft of an automobile drive train, the slip yoke assembly comprising:
a splined sleeve having a proximal end;
a yoke shaft slidably disposed within said splined sleeve and forming a splined joint therebetween, said yoke shaft having an outer surface;
wherein said proximal end of said splined sleeve includes a rod wiper groove configured to house a rod wiper in direct contact with said yoke shaft outer surface to thereby prevent contaminants from entering said slip yoke assembly.

13. An aftermarket slip yoke assembly according to claim 12, wherein said yoke shaft has a proximal end, said slip yoke assembly further comprising a flange yoke removeably coupled to said proximal end of said yoke shaft.

14. An aftermarket slip yoke assembly according to claim 13, wherein said flange yoke has a distal face and wherein at least one of said distal face and said proximal end of said yoke shaft have precision locating features configured to facilitate precisely locating said flange yoke on said proximal end of said yoke shaft.

15. An aftermarket slip yoke assembly according to claim 12, wherein said slip yoke assembly further comprises a drive shaft tube configured to couple said slip yoke assembly to other automobile drive train components, said driveshaft tube having an inner diameter;
said splined sleeve having an inner wall and an outer wall, said inner wall including an internal spline and said outer wall including an outer locating diameter;
wherein said inner diameter of said driveshaft tube is sized and configured for sliding engagement with said outer locating diameter and said outer locating diameter is adjacent said internal spline.

16. An aftermarket slip yoke assembly according to claim 12, wherein said slip yoke assembly further comprises at least one bearing designed and configured to prevent angular misalignment between said splined sleeve and said yoke shaft.

17. An aftermarket slip yoke assembly according to claim 16, wherein said splined sleeve has an inner wall, and wherein said bearing comprises said inner wall and said outer surface of said yoke shaft.

18. A slip yoke assembly according to claim 17, wherein said outer surface is in direct contact with said inner wall.

19. A slip yoke assembly according to claim 17, wherein said slip yoke assembly further comprises a bushing disposed between said outer surface of said yoke shaft and said inner wall of said splined sleeve.

20. A slip yoke assembly according to claim 16, wherein a ratio of a length of said bearing to an outer diameter of said yoke shaft is at least approximately 0.6.

21. An automobile drive train, comprising:
an engine and transmission configured to deliver torque to a driveshaft;
a rear differential mounted on a suspension configured to receive torque from the driveshaft, the suspension permitting movement of the rear differential relative to the engine and transmission;
wherein said driveshaft comprises a slip yoke assembly having;
an outer sleeve having an internal spline;
a yoke shaft slidably disposed within said outer sleeve, said yoke shaft having an external spline configured to engage said internal spline to form a splined joint; and
at least one bearing surface disposed between the outer sleeve and yoke shaft and spaced from the splined joint, said bearing surface configured and dimensioned to resist angular misalignment between said splined sleeve and said yoke shaft.

22. An automobile drive train according to claim 21, further comprising a plurality of universal joints for coupling said driveshaft to said transmission and said rear differential.

23. An automobile drive train according to claim 21, wherein said yoke shaft has an outer diameter, and wherein said bearing surface has a first axial contact length when said yoke shaft is fully extended at a design-maximum-extended position, and wherein a ratio of said first axial contact length to said outer diameter is in a range of about 0.6 to about 2.

24. An automobile drive train according to claim 21, said yoke shaft assembly further comprising a rod wiper, and wherein said splined sleeve includes a rod wiper groove configured to house the rod wiper to thereby prevent contaminants from entering said slip yoke assembly.
